(19) United States
(12) Patent Application Publication
(10) Pub. No.: US 2005/0275644 A1
(43) Pub. Date: Dec. 15, 2005

(54) Method of fast gray-scale converting of LCD

(75) Inventors: Yuh-Ren Shen, Tainan (TW); Cheng-Jung Chen, Chunan Town (TW)

Correspondence Address: DENNISON, SCHULTZ, DOUGHERTY;& MACDONALD, 1727 KING STREET, SUITE 105, ALEXANDRIA, VA, 22314-2700, US

(73) Assignee: VASTVIEW TECHNOLOGY INC.

(21) Appl. No.: 10/866,026

(22) Filed: Jun. 14, 2004

(51) Int. Cl. G09G 5/00

(52) U.S. Cl. 345/204

(57) ABSTRACT

A method of fast gray-scale converting of an LCD comprising the following steps: dividing plural gate lines of an LCD into plural areas; dividing the frame interval time relative to the plural areas into plural sub-intervals, and sequentially activating each first gate line of these areas during a time period of synchronized signals, then sequentially activating the next gate lines of these areas and repeating this operation, wherein at least a gate line is applied by an image data voltage, and at least a gate line is applied by a voltage displaying an all-black image. Repeating the above steps until the entire frame interval is complete and entering the next frame interval. Through dividing of time and space, an object of fast converting the gray-scale of the LCD can be acquired. The method suits for treatment of frames of displays of various LCD's and organic light emitting diodes (OLED's).

### BACKGROUND OF THE INVENTION

1. Field of the Invention

The present invention is related to a method of fast gray-scale converting of an LCD, and particularly to a method which divides a space and a frame interval time of data both of the LCD, simultaneously controls the voltages of gate lines of a plurality of sub-intervals by using synchronized signals, applies a voltage that can get brightness desired to be presented in advance, and applies a voltage that can present an all-black image after getting the desired brightness. This can make fast gray-scale converting to thereby get rid of the phenomenon of a residual image or image overlapping. The method suits for treatment of frames of displays of various LCD's and displays of organic light emitting diodes (OLED's).

2. Description of the Prior Art

Prevailing of LCD's mainly concerns displays of conventional cathode ray tube (CRT), the LCD's have the superiority of low electric consumption, light weight, being without radiation and non flashing, and can be applied on TV's, notebooks or terminals of computers, and gradually become the main stream products of displays.

However, by limitation of the characteristics of liquid crystal molecules, such as the coefficient of viscosity, the coefficient of elasticity and the dielectric coefficient etc., LCD's have their limitation and defects. Referring to FIGS. 1A and 1B showing a simple schematic view of the structure of an LCD, wherein an LCD panel 10 is provided thereon with data drivers 11 for converting adjusted gray-scale signal data into corresponding data voltages, and for outputting image signals through a plurality of data lines 111 of the data drivers 11 to the LCD panel 10. The LCD panel 10 is provided at a side thereof with gate drivers 12 for continuously supplying scanning signals, and for transmitting the scanning signals to the LCD panel 10 through a plurality of gate lines 121 connecting with the gate drivers 12; the data lines 111 cross perpendicularly to the gate lines 121, the area surrounded is a pixel matrix 13.

When the image signals are sent out of the data drivers 11, they provide a source electrode for a transistor Q₁ in the pixel matrix 13 through a data line D₁; and the gate drivers 12 also send out control signals relatively for a gate electrode of the transistor Q₁ through a gate line G₁, and then output an output voltage value through a circuit in the pixel matrix 13. A reaction of the liquid crystal molecules in correspondence with the pixel matrix 13 is activated, the liquid crystal molecules located between two glass base plates of the LCD panel 10 form a parallel-plate capacitor of a liquid crystal C_{LC}. By virtue that the capacitor C_{LC} is unable to keep voltage for the next time when it is to update frame data, hence a storage capacitor CS is added to render the capacitor C_{LC} to keep the voltage for the next time when it is to update the frame data, this type of image displaying is called “Hold Type”.

The brightness between every two frames of an LCD can be maintained without a problem of generating flashing as in a conventional CRT display; a new problem of residual image (afterimage) is induced though. Taking FIG. 2 for explanation, frames F₁, F₂, F₃ and F₄ have different brightness to be presented in the time coordinate, by virtue that it needs time for driving twisting of liquid crystal molecules to make variations of brightness, the variations of brightness and time correspondingly make variations of curve, such as shown by the mark (a) in the drawing. When it is to present brightness, the voltage value is maintained for this brightness. If the time for reaching this brightness occupies the most part of time of displaying a frame, the screen of the display will generate overlapping of the images of the frame and a subsequent frame to induce obscured images, this is a residual image. In fact, variations of brightness of some LCD's are faster during ascending of the variations, and are slower during descending of the variations, this is more subjected to making residual images at times of changing frames.

Conventional CRT displays irradiate electronic beams on screens which are applied with light emitting material through the ends of vacuum tubes to display the colors of frames, the light emitting material on the screens is excited to only transiently generate colors, then the colors disappear and the material waits for the next exciting for the next frame. Such type of displaying is the method of displaying of “Impulse Type”; the curve of variation of brightness in displaying is shown by the mark (b) in FIG. 2, hence there is no residual image incurred between frames.

Therefore, to get rid of the defect of the phenomenon of a residual image, and to take the advantage of the displaying of “Impulse Type” of a CRT display, a pseudo impulse type technique is adopted presently; there are two applicable technical ways to achieve such an object theoretically:
(1) Inserting black data or all-black images into a series of frames of images: as shown in FIG. 3, to insert the all-black images B₁, B₂, B₃ into in the series of frames F₁, F₂, F₃ and F₄, this will force the brightness of latter half section of a frame interval time to disappear to simulate the mode of displaying of a CRT display.
(2) Inserting signals of all-black images into back light sources to make the back light sources flash: as shown in FIG. 3, brightness of each frame is originally provided by light sources in the rear of a display panel of which the back light sources in series are L₁, L₂, L₃ and L₄, signals of a series of all-black images are inserted in between every two of the back light sources, the back light sources are forced to turn off to generate the all-black images B₁, B₂, B₃ Similarly an effect of simulating the mode of displaying of a CRT display is obtained to eliminate the phenomenon of residual images.

In view of these, the inventor of the present invention provided a brand new method of fast gray-scale converting in simulating the mode of displaying of “Impulse Type” of a CRT display based on his professional experience of years in studying and developing in this art, in order to eliminate the problem of residual images of LCD's.

### SUMMARY OF THE INVENTION

The primary object of the present invention is to provide a method of fast gray-scale converting of an LCD, which method divides a space and a frame interval time of data both of the LCD, simultaneously controls the voltages of gate lines of a plurality of sub-intervals by using synchronized signals, applies a voltage that can present an all-black image after getting the brightness desired to be presented. This can make fast gray-scale converting to thereby get rid of the phenomenon of a residual image or image overlapping of the LCD.

To achieve the above object, the method of the present invention comprises:
a. To divide driving gate lines of an LCD downwardly from above into M areas, the total number of the gate lines is Q, wherein a first area includes m₁ gate lines, a second area includes m₂ gate lines . . . a M^{th} area includes m_{M} gate lines, namely

$$Q = {\sum }_{i = 1}^{M} {m}_{i} ,$$

wherein the ratio of the number mᵢ of gate lines included in each area to the total number Q of the gate lines is

$$Pi = \frac{{m}_{i}}{Q} ,$$

therefore,

$${\sum }_{i = 1}^{M} Pi = 1.$$

The ratio Pi is set according to the features of the LCD, and can be set as a constant value or can be adjusted; M is an integer ≧2, and ≦the maximum value that the display panel can generate during a time period of synchronized signals. For the present technical level, M had better be a value between 2 and 6.
b. To divide the frame interval time T into M sub-intervals, wherein the interval time of each sub-interval is tᵢ=PiT, namely,

$${\sum }_{i = 1}^{M} PiT = T .$$
c. To activate each first gate line of the first, the second . . . and the M^{th} areas sequentially during a time period of synchronized signals; then to activate each second gate line of the first, the second . . . and the M^{th} areas sequentially during the next time period of synchronized signals. This operation is repeated, wherein K gate lines are applied by an image data voltage, and J gate lines are applied by a voltage to display all-black images or to darken frames. K and J are both positive integers, satisfying the relation of K+J=M. The amounts K and J are related to the feature of response of the LCD, they can be decided by measuring and observing the curve of response in advance; wherein the frame image in an i^{th} area having been scanned has a time phase difference tᵢ from the frame image in the former area (the (i−1)^{th} area).
d. To repeat the above steps until the end of the entire frame interval time T to complete scanning of frame images.

With the above steps, through dividing of time (frame interval time) and space (gate lines), and by applying the data voltage and the voltage to display all-black images, we can fast convert the gray-scale of the LCD to get rid of the phenomenon of a residual image or image overlapping of the LCD.

From the above statement, the present invention is characterized by dividing the area space of gate lines of a display panel into a plurality of areas, and dividing the frame interval time relative to the plural areas into a plurality of sub-intervals, and sequentially scanning the areas during the time period of synchronized signals, a state of “frame in frame” both in time and space is formed.

The present invention will be apparent after reading the detailed description of the preferred embodiments thereof in reference to the accompanying drawings.

### BRIEF DESCRIPTION OF THE DRAWINGS

FIG. 1A is a schematic view showing the simple structure of a conventional LCD;

FIG. 1B is a partially enlarged schematic view taken from FIG. 1A;

FIG. 2 is a curvilinear figure showing a curve (a) of variation of brightness of an LCD in comparison with a curve (b) of variation of brightness of a CRT display;

FIG. 3 is a schematic view showing displaying of an LCD in displaying of a “Pseudo Impulse Type” of a conventional technique;

FIG. 4 is a curvilinear figure showing curves of variation of brightness of images versus time under various driving voltages;

FIG. 5 is a schematic view showing curves of variation of voltage and variation of brightness of a first embodiment in dividing gate lines into two areas and controlling two gate lines during a time period of synchronized signals in the present invention;

FIG. 6A is a schematic view showing the first embodiment that two gate lines are controlled during a time period of synchronized signals on a display panel at a first time and a second time (within a sub-interval t₁) in the present invention;

FIG. 6B is a schematic view showing the first embodiment that two gate lines are controlled during a time period of synchronized signals on the display panel at a (1/2T)^{th} time (within the sub-interval t₁) and a (1/2T+1)^{th} time (within a sub-interval t₂) in the present invention;

FIG. 6C is a schematic view showing the first embodiment that two gate lines are controlled during a time period of synchronized signals in a scanning area on the display panel at a first time and a second time (within the sub-interval t₁) in the present invention;

FIG. 7 is a schematic view showing a second embodiment of curves of voltage variation and brightness variation of the present invention in which gate lines are divided into three areas in order that three gate lines are controlled and transmitted during a time period of synchronized signals;

FIG. 8A is a schematic view showing the second embodiment that three gate lines are controlled during a time period of synchronized signals on a display panel at a first time and a second time (within a sub-interval t₁) in the present invention; and

FIG. 8B is a schematic view showing the second embodiment that three gate lines are controlled during a time period of synchronized signals on the display panel at a (1/3T)^{th} time (within the sub-interval t₁) and a (1/3T+1)^{th} time (within a sub-interval t₂) in the present invention.

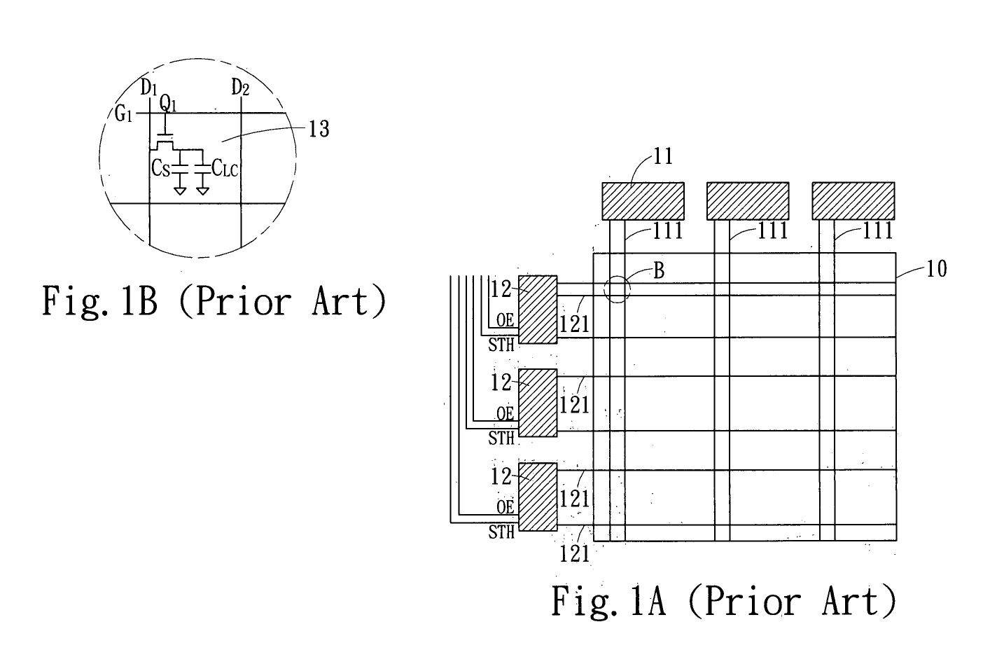

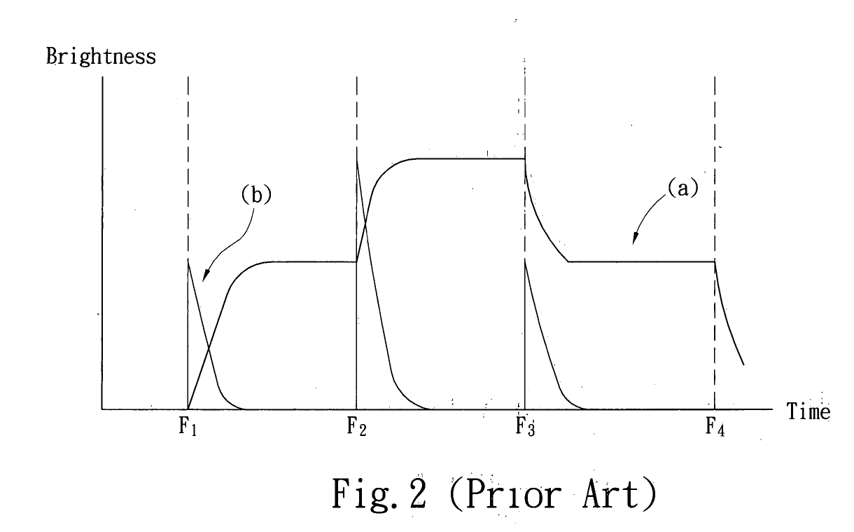

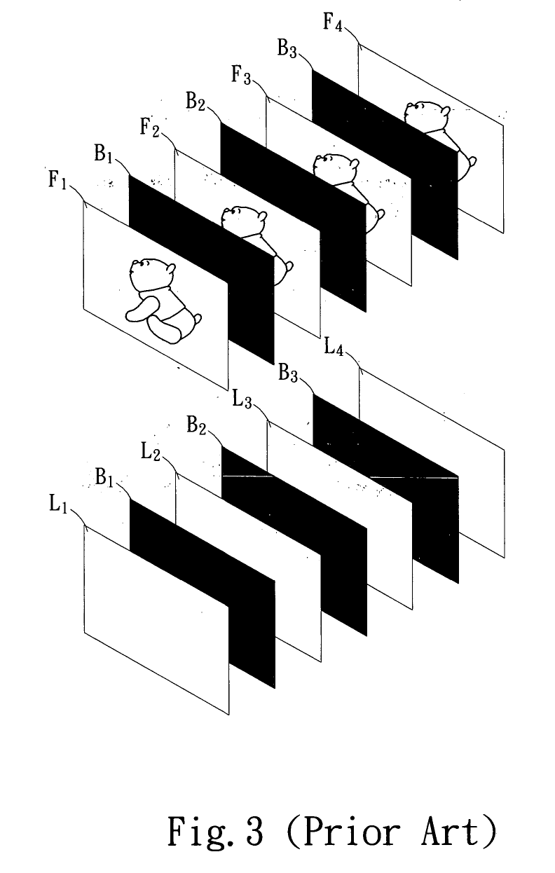

### DETAILED DESCRIPTION OF THE PREFERRED EMBODIMENT

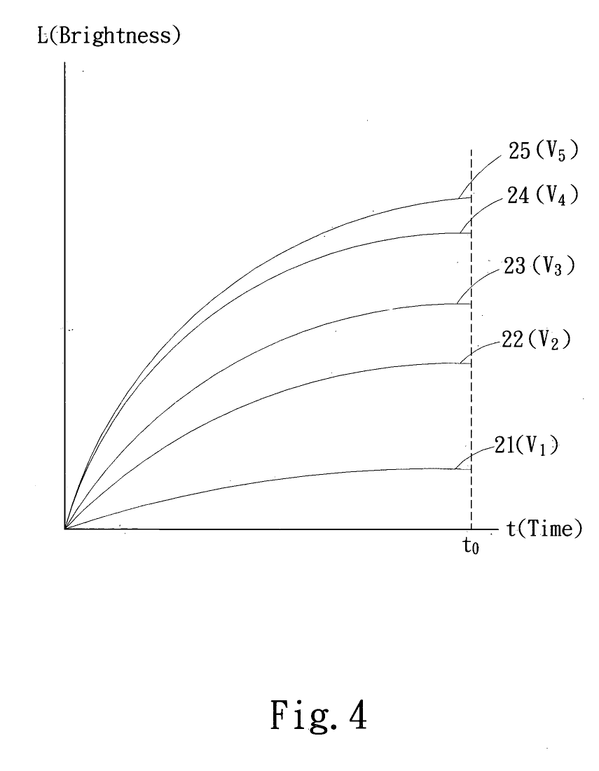

Referring firstly to FIG. 4, because of the differences among various display panels, when in using the method of the present invention, analysis on the feature of a display panel must be performed to set a time t₀ for reaching a predetermined brightness. Taking a gray-scale value (code 120) as an example, assuming that a voltage V₅ can make the display panel reach the brightness desired to be presented by the code 120 within the time t₀. Referring to the curve of variation of brightness labeled as 25 in FIG. 4, the voltage V₅ is recorded, then other different voltages V₁, V₂, V₃ and V₄ are used to drive the display panel of an LCD to make the panel reach the brightness desired. The continuously changing curves of image brightness versus time are shown with the FIGS. 21, 22, 23 and 24. At last, different variations of brightness and their corresponding voltages that the display panel can present is completed. The data of variations of the curves and the corresponding voltages are made a lookup table as a reference in setting the brightness of the panel. Voltages that get the brightness desired to be presented are taken in various embodiments for driving, if they are limited to the characteristics of liquid crystal molecules, elements of another LCD are used for reinforcement, such as improving the back light module of the display etc.

Moreover, a zero gray-scale value of the display means an all-black image that is totally black without brightness. However, in the definition of the present invention, a frame having a gray-scale value for showing all-black image below a value level, such as the code 5˜10, on the LCD can be rightly considered as an all-black image. It still is taken as the code 0 to express that it is a voltage of an all-black image or making darkening of the frame in the specification hereinafter.

### The First Embodiment

To clearly express the technical features of the present invention, an embodiment that the gate lines of the LCD are divided into two areas in order that two gate lines are transmitted during a time period of synchronized signals is taken for explanation.

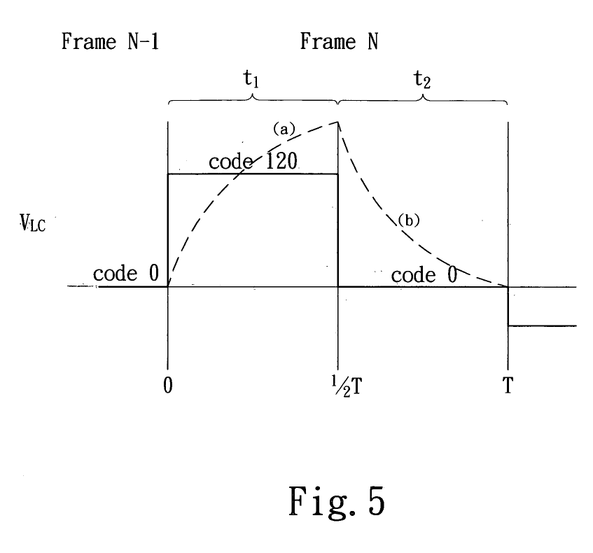

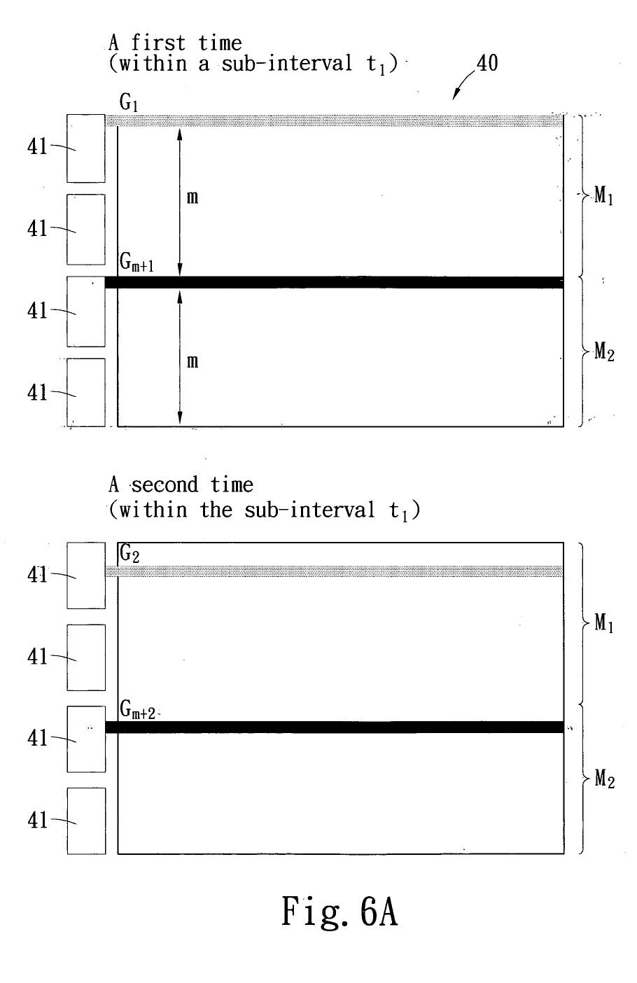

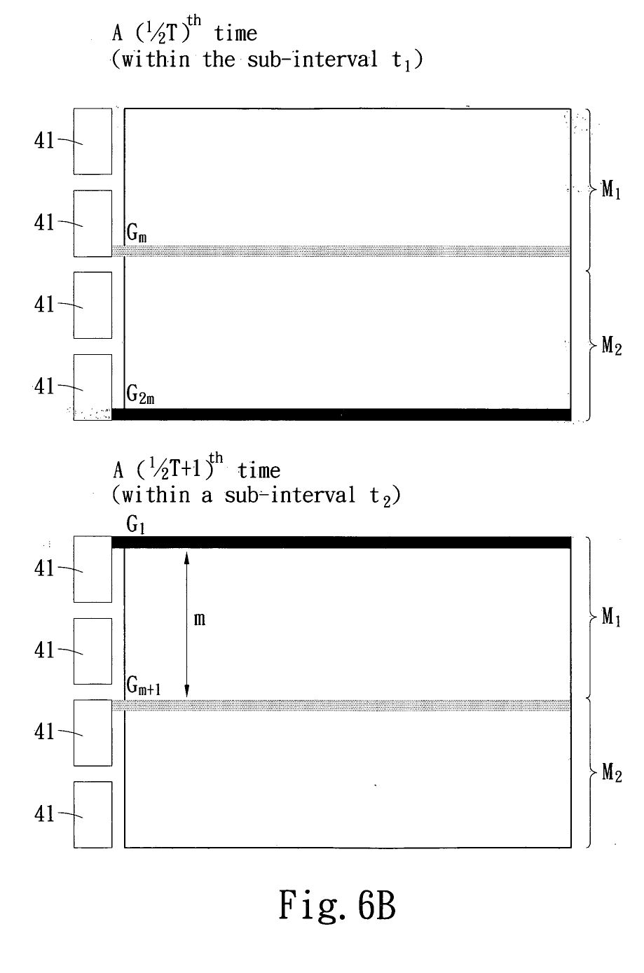

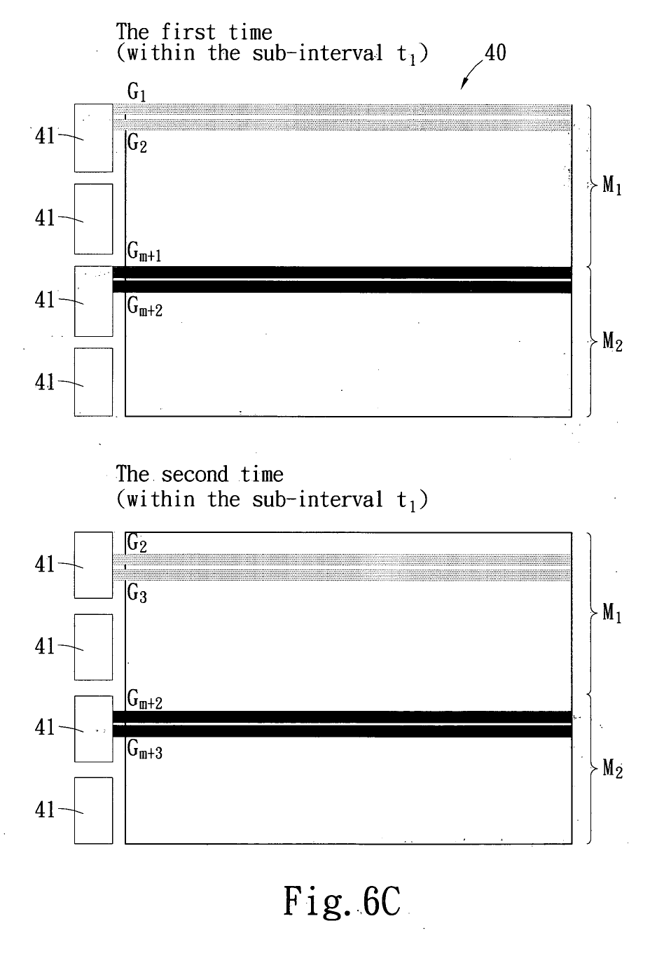

Referring to FIGS. 5, 6A and 6B, wherein FIG. 5 shows curves of voltage waveform and brightness variation (a), (b) output and driven by a pixel at a position of gate line on a display panel 40, wherein the transverse coordinate means time in a unit of ms, the frame interval time thereof is T to be divided into two sub-intervals t₁ and t₂, and t₁:t₂=1:1. FIG. 6A shows that the set gate lines on the display panel 40 are divided into two areas M₁, M₂, assuming that the amount of the gate lines of the first area is m, and the amount of the gate lines of the second area is also m, the total amount of gate lines is 2m, the ratio of amount made from the two gate lines of the two areas thereby is 1:1.

Assuming that the brightness of a series of image data entering the frame interval (Frame N) from a preceding frame interval (Frame N−1) is code 120; this brightness can be obtained by selecting a data voltage from the lookup table to drive the display panel 40, so that the display panel 40 reaches the brightness in a specific time. Practicing of the method of fast gray-scale converting of the present invention is as below:

In the first sub-interval t₁, a gate driver 41 sequentially activates two gate lines on the display panel 40 during a time period of synchronized signals, a data voltage (code 120) for the Frame N is applied to the first gate line G₁, and a voltage (code 0) displaying an all-black image for the preceding Frame N−1 is applied to the first gate line Gₘ₊₁ in the second area M₂; then the next gate lines respectively of the areas are sequentially activated and are applied by the voltages of the same value as those of the former gate lines, i.e., gate lines in an area are all applied by same voltage values, processing goes on till scanning of all the areas is complete. The curve of variation of brightness generated by the data voltage (code 120) is shown by (a) in FIG. 5.

In the second sub-interval t₂, as shown in FIG. 6B, a gate driver 41 sequentially activates the two gate lines on the display panel 40 during a time period of synchronized signals, a voltage (code 0) is applied to the first gate line G₁ in the first area M₁ to display an all-black image, a data voltage (code 120) for the Frame N is applied to the first gate line Gₘ₊₁ in the first area M₂, then the next gate lines respectively of the areas are sequentially activated and are applied by the voltages of the same value as those of the former gate lines, processing goes on till scanning of all the areas is complete. The curve of variation of brightness generated by the voltage (code 0) is shown by (b) in FIG. 5.

The situations of completion of scanning for the first area M₁ and the second area M₂ of the space in this embodiment of practicing are now stated as below: as to the gate lines of the first area M₁, at the time t₁, by driving of the data voltage (code 120) for the Frame N, the brightness desired is obtained; and at the time t₂, by driving of the voltage (code 0) displaying an all-black image, brightness disappears.

As to the gate lines of the second area M₂, at the time t₁, a frame is darkened by the voltage (code 0) displaying an all-black image, this means the all-black image in the last sub-interval for the preceding Frame N−1; and at the time t₂, the data voltage (code 120) for the Frame N drives, this means the brightness desired to be presented by the data in the first sub-interval for the Frame N; thereby, the present invention simultaneously divides the space of the LCD, and the interval time is divided for synchronized signals; this can make the frames of all the areas darken at once when the brightness desired to be presented is obtained, thus an object of fast gray-scale converting is achieved.

The activating during a time period of synchronized signals of the two gate lines in the above embodiment means that there is a time difference between the two gate lines. In practicing, however, we can simultaneously activate and drive plural gate lines in all the scanning areas. Referring to FIG. 6C, in the first sub-interval t₁, the gate driver 41 simultaneously activates two gate lines on the display panel 40 in a scanning area. It simultaneously applies a data voltage (code 120) to the first gate line G₁ and the second gate line G₂ in the first area M₁ for the Frame N; and after a time difference, the first gate line Gₘ₊₁ and the second gate line Gₘ₊₂ in the second area M₂ are simultaneously applied by a voltage (code 0) displaying an all-black image, then the next two gate lines respectively of the areas are sequentially activated, and gate lines of each area are applied by voltages of same value, processing goes on till scanning of all the areas is complete. The process after entering the next sub-interval is same, in this way, the object of fast getting gray-scale converting can be acquired.

The ratio of amount of the gate lines included in each area to the total number of the gate lines will decide the times t₁, t₂, if the response speed of the liquid crystal molecules is fast, the ratio can be lowered, on the contrary, can be increased to extend the time required for the liquid crystal molecules to acquire the desired brightness. This value can be adjusted or constant, and is decided by the features of the display panel.

### The Second Embodiment

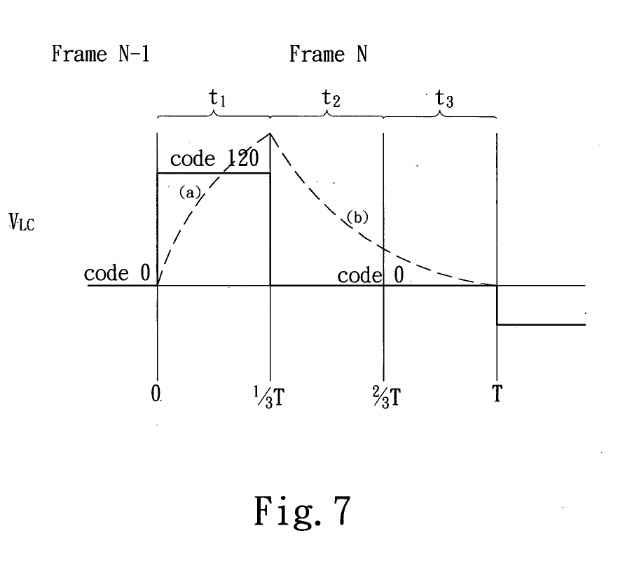

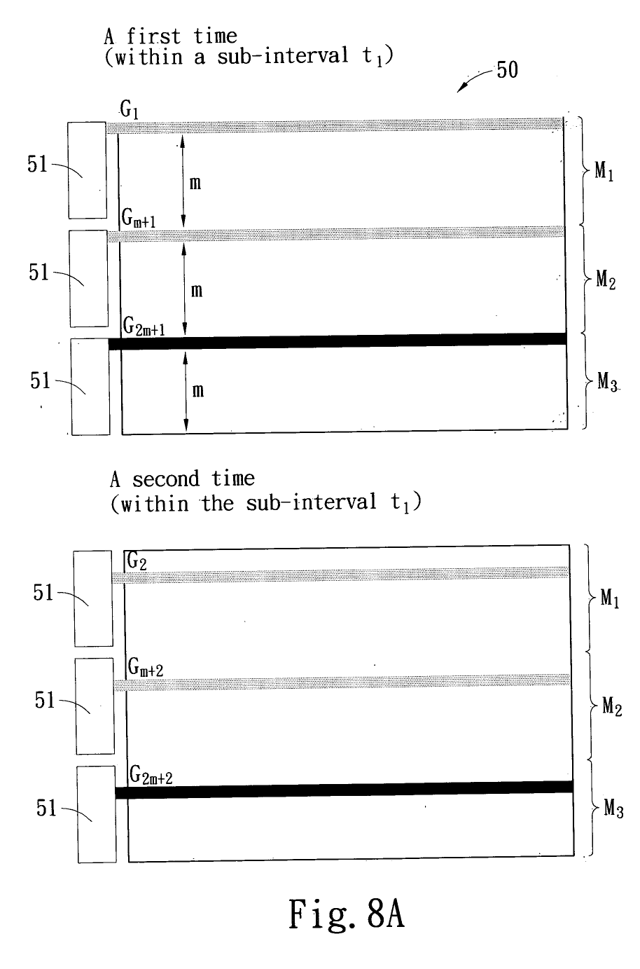

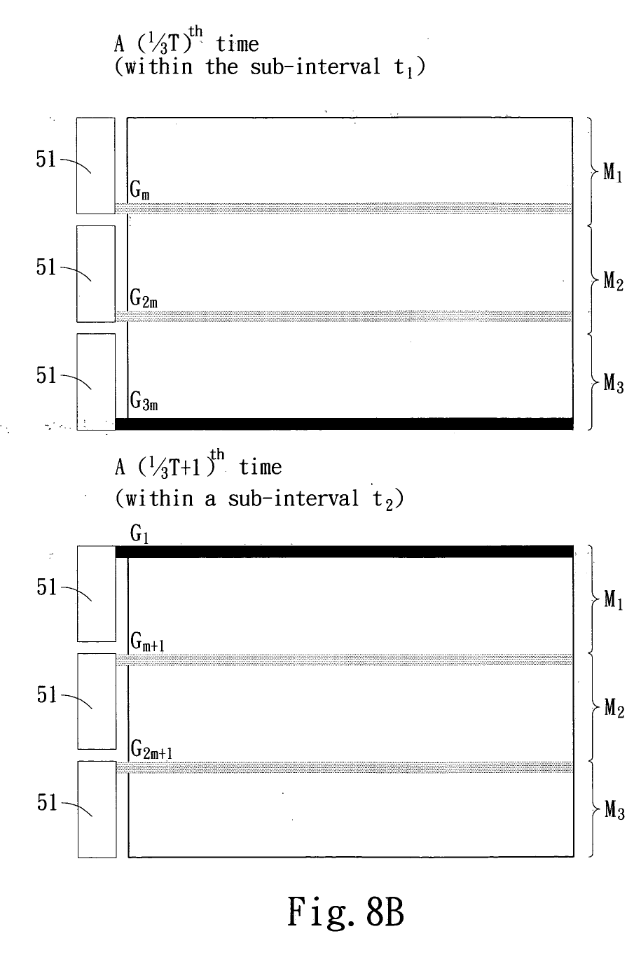

In the second embodiment, gate lines are divided into three areas, synchronic controlling of three scanning signals is taken for explanation here. Referring to FIGS. 7, 8A and 8B, in which FIG. 7 shows curves (a), (b) of voltage waveform and brightness variation output and driven by a pixel at a position of gate line on a display panel 50, the transverse coordinate indicates time with the unit of ms, the frame interval is T, it is divided into three sub-intervals t₁, t₂ and t₃; t₁:t₂:t₃=1:1:1. And referring to FIG. 8A, the gate lines on the display panel 50 are divided into three areas M₁, M₂, M₃. Assuming the amount of the gate lines in the first area is m, and the amount of the gate lines in either of the second and the third areas is m too. The total amount of all the gate lines is 3m, the ratio of the gate lines in these three sub-intervals is 1:1:1.

As shown in FIG. 7, assuming that the brightness desired to be presented of a series of image data entering the frame interval (Frame N) from a preceding frame interval (Frame N−1) is code 120, the brightness is obtained by selecting a data voltage from the lookup table (LUT) to drive the display panel 50. So that the display panel 50 reaches the brightness in a specific time. Practicing of the method of fast gray-scale converting of the present invention is as follows.

In the first sub-interval t₁, a gate driver 51 sequentially activates three gate lines G₁, Gₘ₊₁ and G₂ₘ₊₁ on the display panel 50 during a time period of synchronized signals, a data voltage (code 120) for the Frame N is applied to the first gate line G₁ in the first area M₁. A voltage (code 0) displaying an all-black image for the preceding Frame N−1 is applied to each of the first gate lines Gₘ₊₁ and G₂ₘ₊₁ in the second and third areas M₂, M₃. Then the next gate lines respectively of the areas are sequentially activated and are applied by the voltages of the same value as those of the former gate lines, i.e., gate lines in each area are all applied by same voltage value, processing goes on till scanning of all the areas is complete. The curve of variation of brightness generated by the data voltage (code 120) is shown by (a) in FIG. 7.

In the second sub-interval t₂, as shown in FIG. 8B, a gate driver 51 sequentially activates three gate lines on the display panel 50 during a time period of synchronized period, a voltage (code 0) displaying an all-black image in the last sub-interval for the preceding Frame N−1 is applied to each of the gate lines of the first area M₁ and the third area M₃, the gate lines of the second area M₂ are applied by a data voltage (code 120) for the Frame N, then each of the gate lines of the areas are sequentially activated during the time period of synchronized signals, and processing goes on till scanning of all the areas is complete.

In the third sub-interval t₃, a voltage (code 0) displaying an all-black image in the last sub-interval for the preceding Frame N−1 is applied to each of the gate lines of the first area M₁ and the second area M₂, the gate lines of the third area M₃ are applied by a data voltage (code 120) for the Frame N, and processing goes on till scanning of all the areas is complete. The curve of variation of brightness generated in the sub-interval t₂, t₃ is shown by (b) in FIG. 7.

The situations of completion of scanning for the areas M₁, M₂ and M₃ of the space in this embodiment of practicing are now stated as below: as to the gate lines of the first area M₁, at the time t₁, by driving of a data voltage (code 120) for the Frame N, the brightness desired is obtained; and at the sub-intervals t₂ and t₃, a voltage (code 0) displaying an all-black image is applied for each.

As to the gate lines of the second area M₂, at the first sub-interval t₁, a voltage (code 0) displaying an all-black image for the preceding Frame N−1 is applied. At the time t₂, a data voltage (code 120) for the Frame N is applied; and at the time t₃, a voltage (code 0) displaying an all-black image is applied. Its completion of scanning has a time difference t₂ from that of the areas M₁.

As to the gate lines of the third area M₃, at the sub-intervals t₁, t₂, a voltage (code 0) displaying an all-black image in the last sub-interval for the preceding Frame N−1 is applied; and at the time t₃, a data voltage (code 120) for the Frame N is applied. Its completion of scanning has a time difference t₃ from that of the areas M₂.

Analogizing according to the above two embodiments, the present invention is suitable for activating M gate lines during a time period of synchronized signals, wherein the scanning area of an LCD are divided into M areas, and the object of the present invention can be achieved, the method of this is described as below:
a. to divide the gate lines of an LCD downwardly from above into M areas, the total number of the gate lines is Q, wherein the first area includes m₁ gate lines, the second area includes m₂ gate lines . . . the M^{th} area includes mM gate lines, namely

$$Q = {\sum }_{i = 1}^{M} {m}_{i} ,$$

wherein the ratio of the number mᵢ of gate lines included in each area to the total number Q of the gate lines is

$$Pi = \frac{{m}_{i}}{Q} ,$$

therefore,

$${\sum }_{i = 1}^{M} Pi = 1 ,$$

the ratio Pi is set according to the features of the LCD, and can be set as a constant value or can be adjusted; M is an integer ≧2, and ≦the maximum value that the display panel can generate during a time period of synchronized signals;
b. to divide the frame interval time T of the LCD into M sub-intervals in correspondence with the M areas, wherein the interval time of each sub-interval is tᵢ=PiT, namely,

$${\sum }_{i = 1}^{M} PiT = T ;$$
c. to activate each first gate line of the first, the second . . . and the M^{th} areas sequentially during a time period of synchronized signals; then to activate each second gate line of the first, the second . . . and the M^{th} areas sequentially during the next time period of synchronized signals; the operation is repeated, wherein K gate lines are applied by an image data voltage, and J gate lines are applied by a voltage displaying an all-black image; K and J are both positive integers, satisfying the relation of K+J=M; the amounts K and J are related to the feature of response of the LCD, they can be decided by measuring and observing the curve of response in advance; as for the second embodiment, J is 1, K is 2;
d. to repeat the above steps until the end of the entire frame interval time T to enter the next frame interval, the frame image in an i^{th} area having been scanned has a time phase difference tᵢ from the frame image in the former area (the (i−1)^{th} area).

With the above steps, through dividing of time (frame interval time) and space (gate lines), and by applying the data voltage and the voltage to display an all-black image, an object of fast getting the gray-scale converting of the LCD can be acquired. For the present technical level, M had better be a value between 2 and 6; the synchronized signals can also simultaneously activate plural gate lines in each scanned area, the range of the amount of gate lines is from 2 to the amount of the gate lines in the first area, or all the gate lines of the LCD can be activated simultaneously, scanning can be progressed in a multiplied-frequency mode. The driving method of the present invention is applicable to displays of various LCD's, active matrix typed LCD's and displays of organic light emitting diodes (OLED's).

We can see from the above statement a technical state of “frame in frame” of the present invention. The embodiments given are only for illustrating the present invention, and not for giving any limitation to the scope of the present invention. It will be apparent to those skilled in this art that various modifications or changes without departing from the spirit of this invention shall also fall within the scope of the appended claims.

Therefore, the present invention has the following advantages:
1. it can make fast gray-scale converting to thereby realize an object of getting rid of the phenomenon of a residual image by a technique of “frame in frame” of the present invention;
2. it divides the scanning area of a display panel into a plurality of scanning areas, the ratio of each scanning area is fixed or adjustable according to the features of the display panel, the present invention is applicable to displays of various display panels, thereby is extremely industrial valuable.

In conclusion, according to the description disclosed above, the present invention surely can get the expected object thereof to provide a method of fast gray-scale converting of an LCD, the method is extremely industrial valuable.

Having thus described my invention, what I claim as new and desire to be secured by Letters Patent of the United States are:

1. A method of fast gray-scale converting of an LCD, said method comprises the steps of:
a. to divide gate lines of an LCD downwardly from above into M areas, the total number of said gate lines is Q, wherein a first area includes m₁ gate lines, a second area includes m₂ gate lines . . . an M^{th} area includes m_{M} gate lines, namely
$$Q = {\sum }_{i = 1}^{M} {m}_{i} ,$$
wherein a ratio of said number mᵢ of gate lines included in each of said areas to a total number Q of said gate lines is
$$Pi = \frac{{m}_{i}}{Q} ,$$
therefore,
$${\sum }_{i = 1}^{M} Pi = 1 ;$$
b. to divide an entire frame interval time T of said LCD into M sub-intervals in correspondence with said M areas, wherein the time interval of each of said sub-intervals is tᵢ=PiT, namely,
$${\sum }_{i = 1}^{M} PiT = T ;$$
c. to activate each first gate line of said first, said second . . . and said M^{th} areas sequentially during a time period of synchronized signals; then to activate each second gate line of said first, said second . . . and said M^{th} areas sequentially during a next time period of synchronized signals; operation of said step is repeated, wherein K gate lines are applied by an image data voltage, and J gate lines are applied by a voltage displaying an all-black image; K and J are both positive integers, satisfying the relation of K+J=M;
d. to repeat said steps a-c until an end of said entire frame interval time T to enter said next frame interval, an frame image in an i^{th} area having been scanned has a time phase difference tᵢ from a frame image in a former area (the (i−1)^{th} area);
with said steps a-d, through dividing of time (said frame interval times) and space (said gate lines), and by applying said data voltage and said voltage to display said all-black image, an object of fast getting said gray-scale converting of said LCD is acquired.

2. The method of fast gray-scale converting of an LCD as in claim 1, wherein:
said ratio Pi is set according to features of said LCD, and is alternatively set as a constant value or to be adapted to adjusting.

3. The method of fast gray-scale converting of an LCD as in claim 1, wherein:
said M is an integer ≧2, and ≦the maximum value that a panel of said LCD generates during a time period of synchronized signals.

4. The method of fast gray-scale converting of an LCD as in claim 3, wherein:
said M is preferably a value between 2 and 6.

5. The method of fast gray-scale converting of an LCD as in claim 1, wherein:
said amounts K and J are related to a feature of response of said LCD, and are decided by measuring and observing a curve of response in advance.

6. The method of fast gray-scale converting of an LCD as in claim 1, wherein:
said all-black image is a frame being relatively dark, and is adapted to making said frame darken in pursuance to brightness of a background by adjusting of voltage.

7. The method of fast gray-scale converting of an LCD as in claim 1, wherein:
said method suits for active matrix LCD's and displays of organic light emitting diodes (OLED's).

8. The method of fast gray-scale converting of an LCD as in claim 1, wherein:
controlled signals during a time period of synchronized signals are adapted to simultaneously activating a plurality of gate lines in any of said scanned areas, the range of amount of said gate lines is from 2 to an amount of said gate lines in said first area.

9. The method of increasing image gray-scale response speed as in claim 1, wherein:
all said gate lines of said LCD are activated simultaneously, scanning is progressed in a multiplied-frequency mode.
